(19) United States
(12) Patent Application Publication
(10) Pub. No.: US 2023/0048371 A1
(43) Pub. Date: Feb. 16, 2023

(54) GEARWHEEL BODY OF ROBUST LIGHTWEIGHT CONSTRUCTION FOR ELECTRIC DRIVES

(71) Applicant: ZF FRIEDRICHSHAFEN AG, Friedrichshafen (DE)

(72) Inventors: Josef Otta, Friedrichshafen (DE); Sai Vignesh Varadarajan, Telangana (IN); Florian Falkner, Hauzenberg (DE); Karl Binder, Passau (DE); Lingling Pan, Shanghai (CN); Christoph Schwarzbauer, Windorf (DE)

(21) Appl. No.: 17/881,910

(22) Filed: Aug. 5, 2022

(30) Foreign Application Priority Data
Aug. 10, 2021 (DE) 10 2021 208 663.2

(51) Int. Cl. F16H 55/17; F16H 57/00; F16H 57/02

(52) U.S. Cl. CPC F16H 55/17; F16H 57/0006; F16H 57/02; F16H 2057/02052; F16H 2057/02034

(57) ABSTRACT

A gearwheel body of structure-borne sound-reducing lightweight construction for electric drives in which shifting of the contact pattern of the wheel body under load is minimized in the case of a gearwheel body having a structured web extending substantially within a radial plane between a shaft seat and a toothed ring. The web has spiral structures that are thickened in a rib-like manner, and the spiral structures are aligned in such a way that their spiral shape meets at least the toothed ring at an oblique angle.

### BACKGROUND OF INVENTION

### 1. Field of the Invention

The disclosure relates to a gearwheel body of structure-borne sound-reducing lightweight construction for electric drives, having a toothed ring and a wheel hub, which has a structured web extending substantially within a radial plane between a shaft seat and the toothed ring. The field of application is in electric drive engineering involving solid lightweight transmission elements, particularly in vehicle engineering in applications for electric mobility. Owing to the absence of masking noise known from internal combustion engines, the sound emissions of the electric transmission, which are low per se, are perceived as being troublesome by the vehicle occupants in some cases.

### 2. Description of Related Art

In electric drives, the mass of the overall system plays a very important role. Consequently, the drive gearwheels require a lightweight design and a reduction in the mass of the wheel body by the creation of a mass-reduced web between the shaft seat and the toothed ring.

Due to the service life specifications for transmissions in electric vehicles, this leads to significantly increasing requirements on the stability of the individual gearwheels, which can be enhanced particularly by increasing the gearwheel diameter and/or the tooth width.

Given the abovementioned boundary conditions, one significant approach to ensuring stability with the lowest possible mass of the gearwheel is that of optimizing the design of the gearwheel body. However, neither the inner shaft seat of the gearwheel hub nor the outer toothed ring on lightweight construction gears are suitable for this purpose because of the boundary conditions described above. The design changes can therefore be made only in the intermediate web of the gearwheel. However, the latter must not be at the expense of the stipulated torque transmission.

In the case of meshing gearwheels with helical toothing for an enlarged engagement area per tooth, there is shifting of the contact pattern, due primarily to gearwheel deformation, but also to shaft deformation, bearing play, and housing deformation, as a result of which there is no uniform load distribution over the tooth width, and this can lead to troublesome structure-borne sound emission when the edge regions of the toothing come into engagement.

The common way of minimizing this sound emission is to optimize the macro- and micro-geometry of the toothing. However, this measure is not entirely adequate. A further new approach is to minimize the shifting of the contact pattern under load by optimum design of the wheel body to ensure that the edge regions of the toothing are not so heavily stressed.

The challenge for the design of the transmission and individual gearwheel bodies is thus to reduce the alignment errors due to dynamic deformations of the gearwheel body in some other way.

Approaches known from the prior art which take into account the lightweight construction requirements of gearwheels are often aimed only at weight reduction. A disclosure in this respect has been made by EP 3 667 124 A1, in which the gearwheel hub is connected between the metallic shaft seat and the metallic toothed ring by a web of plastic (resin) having an equally distributed hole structure and engagement in a groove of each individual tooth region of the toothed ring. The non-monolithic construction must be regarded as disadvantageous for the stiffness and fatigue strength of the gearwheel. Unfortunately, no information can be gathered about structure-borne sound emission due to alignment errors of the gearwheel body's tooth flanks, which mesh under load and at high rotational speeds, nor about the prevailing natural frequency spectrum.

Other conventional solutions for weight reduction rely on a mass reduction in the web of the gearwheel body, in that either hole patterns are introduced or spokes are formed or a combination of the two approaches is used, as illustrated by way of example in FIG. 2.

### SUMMARY OF THE INVENTION

One aspect of the invention is a gearwheel body of structure-borne sound-reducing lightweight construction for electric drives in which the shifting of the contact pattern under load is minimized to such an extent that no troublesome structure-borne sound emissions of the electric drive occur.

One aspect of the invention is a gearwheel body of structure-borne sound-reducing lightweight construction for electric drives having a toothed ring and a wheel hub, which has a structured web extending substantially within a radial plane between a shaft seat and the toothed ring, in that the web has spiral structures which are thickened in a rib-like manner, and the spiral structures are aligned in such a way that their spiral shape meets at least the toothed ring at an oblique angle.

The spiral structures are advantageously arranged in such a way that their spiral shape additionally meets the shaft seat at an oblique angle.

In a preferred variant, the web can be formed by spiral structures in two radial planes situated one behind the other about the axis of rotation of the gearwheel body. In this case, the spiral structures in the two radial planes of the web which are situated one behind the other are expediently arranged in opposite directions about the axis of rotation of the gearwheel body. The spiral structures in the two radial planes of the web which are situated one behind the other can advantageously be connected in a single monolithic web, it being expediently possible for the monolithically connected spiral structures of the two radial planes of the web to be produced by additive or subtractive production methods (FIG. 3).

In a first configuration of the web, the spiral structures can advantageously be arranged in the same size and the same tangential spacing about the axis of rotation of the gearwheel body.

In a second embodiment, the spiral structures are preferably arranged in the same size and at different tangential spacings about the axis of rotation of the gearwheel body, but have a 2n-fold rotational symmetry with respect to the axis of rotation in order to avoid imbalance.

In this case, the web has adjacent, differently structured sectors with different mass distribution, which are present in pairs and can be brought into congruence after a rotation of 180° about the axis of rotation of the gearwheel body. Here, the different mass distribution in the various sectors can expediently be set by varying the position, number or size of the spiral structures, apertures or combinations of these variations of the mass distribution.

The structure of the web can advantageously be formed by a combination of at least two of the spiral structures comprising ribs, apertures, wavy structures, beads or pockets.

One aspect of the invention is based on the insight that, in the case of lightweight gearwheels, the mass of the gearwheel is concentrated mainly outside the axis of rotation on account of the thinned-out wheel hub (web between shaft seat and toothed ring) and can thus lead to relatively low natural frequencies of the gearwheel bodies.

The core concept of the invention is now to modify the design of radial spoke or bead and/or hole structures within the web between the shaft seat and the toothed ring of the gearwheel body, which is already used conventionally, in such a way that, while maintaining the greatest possible lightweight design of the gearwheel body, a spiral shape of spoke or bead structures of the web is produced, which may be provided with openings or apertures.

Due to the combination of load effects on the toothed ring in radial, axial and tangential directions, the rib, spoke or similar structures in the web should be arranged so as to be angled or sloped, particularly with respect to the toothed ring, preferably being rounded or curved.

Such spiral structures are preferably aligned in opposite directions in different radial planes of the web or can be formed from the remaining material of the web by correspondingly shaped apertures. The gearwheels according to one aspect of the invention, which are formed in this way, with spiral, rib-like structures, have higher natural frequencies and less shifting of the contact pattern than radial rib or spoke structures with the same mass.

A particularly preferred solution for suppressing structure-borne sound emission is achieved in that the spiral structural elements (spokes, beads, or apertures) are arranged in the web of the gearwheel by their non-cyclic distributions about the axis of rotation. This results in uneven mass distribution, which, however, (without imbalance) has an at least two-fold rotational symmetry about the axis of rotation, with the result that the symmetrical eigenmodes are split and distributed between different frequencies.

For the deviation from the cyclic uniform mass distribution, the following approaches exist in principle in the manufacture of a gearwheel or its hub if the latter is designed as an approximately annular web between the shaft seat and the toothed ring:
a non-cyclic position, shape or size of holes (arbitrarily produced apertures or openings),
a non-cyclic position, shape or size of successive ribs or spokes, or
a wavy design of the web of non-cyclically successive beads, pockets or similar structures.

Moreover, combinations of at least two of these approaches are possible.

The structures of the web on the gearwheel hub, which deviate from cyclicity or symmetry, should be interpreted as follows. There is no rotational symmetry in the narrower sense, but only rotational symmetry in the wider sense, i.e. the structures of the web have an even-numbered order (C=2n, where n=1, 2, 3, . . . ) with respect to the axis of rotation of the gearwheel. This means that when at least two different structures are formed, the respective structure must be brought into congruence with an identically formed structure after a rotation of the gearwheel by φ=180°. For non-cyclic mass distribution, at least two different mass distributions must be formed in adjacent sectors of the wheel hub.

This type of abovementioned cyclicity deviations, which splits at least two natural frequencies of the gearwheel into oscillation modes of different frequencies, makes it possible, if the split frequencies are far enough apart, to reduce the superposition of symmetrical natural frequencies, thereby suppressing the resonance peaks.

With the aid of one aspect of the invention, a new possibility for designing a gearwheel body of structure-borne sound-reducing lightweight construction for electric drives is achieved by a robust gearwheel design having spiral structures of the web in which resonant frequencies of the wheel body are significantly increased and the shifting of the contact pattern of the wheel body under load is minimized to such an extent that the edge regions of the toothing are subjected to less severe loading and, as a result, no troublesome structure-borne sound emissions of the electric drive occur.

The gearwheel body is advantageously designed as a cylindrical wheel.

In addition, one aspect of the invention relates to a transmission device having at least two cylindrical wheels for transmitting a rotational speed and/or a torque of an electric motor, wherein the gearwheel is designed as a cylindrical wheel and as described.

One aspect of the invention also relates to an electric axle drive for a motor vehicle having at least one electric machine, a transmission device, a differential and an inverter. The electric axle drive is distinguished by the fact that the transmission device is designed as described.

In addition, one aspect of the invention relates to a motor vehicle comprising an electric axle as described and/or a transmission device as described.

### BRIEF DESCRIPTION OF THE DRAWINGS

The invention is explained in greater detail below with reference to exemplary embodiments and figures. More specifically:

FIG. 1: is a schematic illustration of the gearwheel body in lightweight construction with spiral ribs, which meet the toothed ring at an oblique angle;

FIG. 2: is a schematic illustration of a conventional gearwheel body according to the prior art in an embodiment with radial ribs and holes, which is common for lightweight construction;

FIG. 3A, 3B: are a gearwheel body with a particularly robust lightweight construction, in which oppositely spirally shaped ribs are present in two axially offset radial planes, FIG. 3A showing a front view and FIG. 3B a rear view;

FIG. 4: is a gearwheel body in which the ribs, which meet the toothed ring obliquely in a spiral shape from the inside, are directed counter to the tangential forces acting on the helical toothing from the outside;

FIG. 5: is a gearwheel body, in which the ribs, which meet the toothed ring obliquely in a spiral shape from the inside, are not equally distributed about the axis of rotation of the gearwheel but have a two-fold rotational symmetry about the axis of rotation; and

FIG. 6A, 6B: is a gearwheel body with spirally embodied beads and/or pockets in a plan view (FIG. 6A) and an axial section (FIG. 6B), it being possible for the spiral direction of the beads in two different radial planes to be opposed.

### DETAILED DESCRIPTION OF THE PRESENTLY PREFERRED EMBODIMENTS

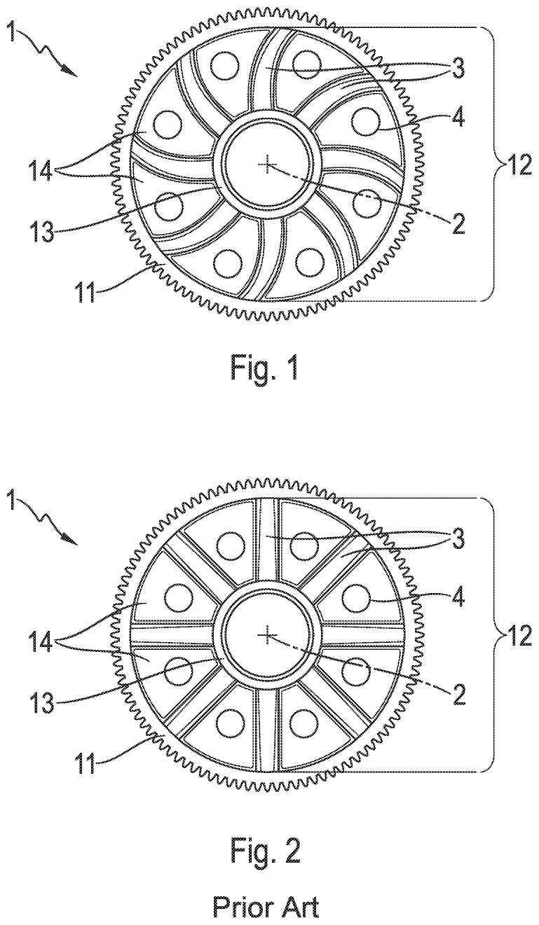

FIG. 1 serves to explain the fundamental structure of the gearwheel body in the lightweight design according to the invention. The gearwheel body 1 comprises a toothed ring 11 and a gearwheel hub 12.

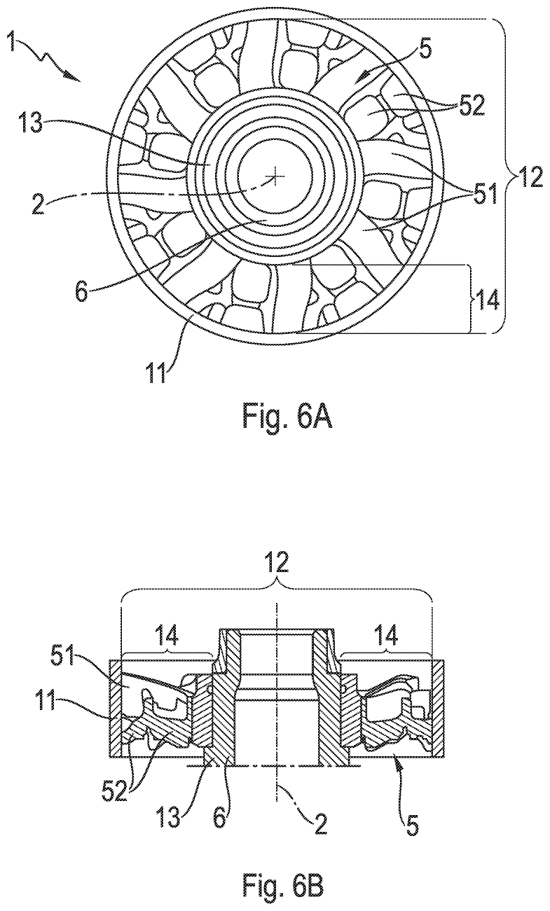

The toothed ring 11 is provided with helical toothing to enlarge the contact area when meshing with a second gearwheel, such as the drive shaft of an electric motor. In order to reduce the weight with a view to lightweight construction, the gearwheel hub 12 is of narrower design than the toothed ring 11, and therefore a web 14, which extends substantially within a radial plane is formed between a shaft seat 13 and the toothed ring 11 and is provided with spirally thickened rib-like structures, the structures being formed from ribs 3 or beads 51 (shown in FIG. 6) alternately with apertures 4, e.g. in the form of drill holes or other holes deviating from the circular shape, and/or other wavy structures 5, such as pockets 52. In this case, the structures produced from ribs 3 or by beads 51 are aligned in such a way that their spiral shape meets at least the toothed ring 11 at an oblique angle, ensuring that all the ribs 3 counteract the tangential forces occurring on the outside of the toothed ring 11 at the points of contact with the toothed ring 11. It is also advantageously possible for the ribs 3 to be positioned obliquely at the shaft seat 13.

In this basic example, the ribs 3 and the apertures 4 are arranged in the same size and the same radial and tangential spacing about the axis of rotation 2 of the gearwheel body 1.

In order to explain the overall problem, FIG. 2 shows the lightweight construction in the conventional design according to the prior art in a stylized form. A gearwheel body 1 is structured with radial ribs 3 or, if appropriate, spokes on the web 14, wherein the ribs 3 meet the toothed ring 11 from the inside in a manner distributed equally about the axis of rotation 2 and—owing to the radial alignment—orthogonally.

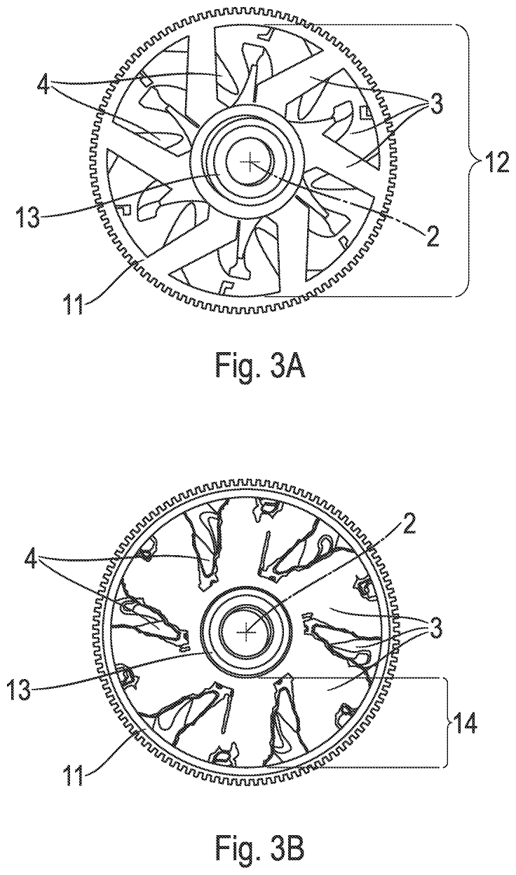

The solution to the problem according to one aspect of the invention is shown in the schematic illustration in FIG. 3. The gearwheel body 1 is shown in stylized form in a plan view as a front view (FIG. 3A) and as a rear view (FIG. 3B), wherein the web 14 is shown between the toothed ring 11 and the shaft seat 13 in two radial planes lying one behind the other, in which spiral ribs 3 with opposite alignment have been selectively produced. The structures produced from the ribs 3 can be arranged in an axially separate manner one above the other, or can merge into one another between the two radial planes.

Owing to the novel possibilities in the lightweight construction of gearwheels by additive and subtractive production methods, the structures shown in this example are simple to generate in order to produce the intersecting spiral ribs 3 of the two radial planes as a single monolithic structure of the web 14. Outside the intersecting spiral ribs 3, specially shaped apertures 4 with an approximately almond-shaped appearance are formed in the overall structure. As a result of the oppositely oriented spiral ribs 3, this design of the gearwheel body 1 is particularly robust and suitable particularly for alternating loads with reversal of the direction of rotation.

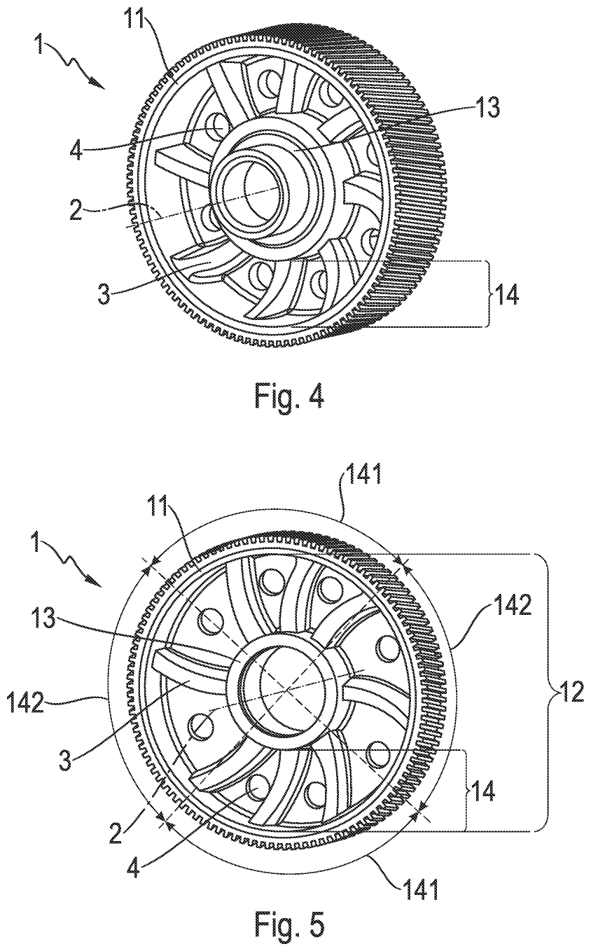

FIG. 4 shows a perspective illustration of another embodiment of the gearwheel body 1, in which the web 14 again has spiral ribs 3 of considerable thickness and is thinned out between them by drill holes as apertures 4, with the result that a type of spoke structure with angles of incidence of the ribs 3 or beads 51 or spoke structure oriented counter to the tangential forces acting on the outside of the toothed ring 11 is formed.

A particularly preferred embodiment of the gearwheel body 1 can be seen in FIG. 5 in a three-dimensionally illustrated plan view.

In this configuration of the gearwheel body 1, the high natural frequencies, which may be superposed to produce resonance peaks in certain torque ranges, are divided into two different frequency ranges. The solution lies in the fact that, in the arrangement of the structures of ribs 3 or beads 51, and of apertures 4 optionally located therebetween, the absolute uniform distribution of mass or rotational symmetry in the narrow sense is modified into a rotational symmetry in the wider sense.

For this purpose, at least two differently structured sectors 141, 142 are placed in the web 14 of the gearwheel body 1, which sectors each have an identical counterpart lying axially symmetrically opposite with respect to the axis of rotation 2. Here, differently structured means that the adjacent sectors 141, 142 have mutually different mass distributions (a mass difference) which, when the gearwheel body 1 is rotated about the axis of rotation 2, generate different eigenmodes at different frequencies, ensuring that they are not superposed to form resonance peaks.

As a result of the sectors 141, 142 with the same structure lying axially symmetrically opposite one another in pairs, there is no imbalance here during the rotation of the gearwheel body 1. For this purpose, in the sectors 141, 142 illustrated in FIG. 5, the ribs 3 are arranged with in each case one hole 4 between them of the same size and shape, either as a triple (sectors 141) or as an individual rib 3 between two holes 4 (sectors 142), as a result of which the mass distribution in the sectors 141, 142 is obviously significantly different.

Owing to the novel possibilities in the lightweight construction of gearwheel bodies 1 by additive and subtractive production methods, the examples in FIG. 5 are in no way restricted to the circular holes 4 shown but can be replaced by, or combined with, apertures 4 of any desired shape, such as rounded triangles, quadrilaterals, any desired polygons, ovals, etc.

In FIG. 6, the web 14 of the gearwheel body 1 has been structured with a corrugated structure 5, produced according to the principle of FIG. 1 or 4, as illustrated in the plan view of FIG. 6A.

Alternating spiral structures consisting of spiral beads 51 and spirally offset pockets 52 can be seen, the latter in each case likewise jointly producing a type of rib or spoke structure, as can be seen in the axial section of FIG. 6B. In this illustration, the shaft seat 13 is shown mounted on a shaft stub 6, which is important particularly for overhung mounting of the drive shaft of the gearwheel body 1.

The beads 51 indicated in FIG. 6A can also be designed as thickened portions in the sense of ribs 3 with an increase in stiffness due to deformation. Likewise, the spirally offset pockets 52 are suitable for contributing, by deformation steps (punching, embossing, etc.), to a further increase in the stiffness of the web 14 by spirally extending embossed edges of the offset pockets 52. In addition, the beads 51 and offset pockets 52 can also be arranged according to the principles of unequal mass distribution in adjacent sectors 141 and 142 (shown in FIG. 5) in order to generate different natural frequencies that are not superposed to give resonances.

With the above-described variant embodiments of the invention, the customary radial structuring with ribs 3 in a gearwheel body 1 of lightweight design is thereby converted, primarily in the mass-reduced web 14, into a more robust design in such a way that the ribs or comparable structures between the shaft seat 13 and the toothed ring 11 are formed as a spiral structure having an end that meets at least the toothed ring 11 at an oblique angle. This structuring is not restricted as to the type of structure and its production as long as there is a spiral profile between the toothed ring 11 and the shaft seat 13 of the gearwheel body 1 or an oblique angle of incidence of the structure on the inside of the toothed ring 11. Moreover, the further reduction of the generation of structure-borne sound is part of the invention insofar as, by virtue of the spirally arranged structures, a non-cyclic structure arrangement along the tangential direction of the web 14 is set as an at least two-fold rotational symmetry.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A gearwheel body of structure-borne sound-reducing lightweight construction for electric drives, comprising:
a toothed ring; and
a wheel hub;
a structured web extending substantially within a radial plane between a shaft seat and the toothed ring,
wherein the structured web has spiral structures which are thickened in a rib-like manner and are directed from the shaft seat to the toothed ring, and
wherein the spiral structures are aligned such that their spiral shape meets at least the toothed ring at an oblique angle.

2. The gearwheel body as claimed in claim 1, wherein the spiral structures are arranged such that their spiral shape meets the shaft seat at an oblique angle.

3. The gearwheel body as claimed in claim 1, wherein the structured web is formed by respective spiral structures in two radial planes situated one behind the other about an axis of rotation of the gearwheel body.

4. The gearwheel body as claimed in claim 3, wherein the respective spiral structures in the two radial planes of the structured web are arranged in opposite directions to one another about the axis of rotation of the gearwheel body.

5. The gearwheel body as claimed in claim 3, wherein the respective spiral structures in the two radial planes are connected in a single monolithic web.

6. The gearwheel body as claimed in claim 5, wherein the monolithically connected spiral structures are produced by additive or subtractive production methods.

7. The gearwheel body as claimed in claim 1, wherein the spiral structures (are arranged in a same size and with a same tangential spacing about an axis of rotation of the gearwheel body.

8. The gearwheel body as claimed in claim 1, wherein the spiral structures are arranged in a same size and at different tangential spacings about an axis of rotation of the gearwheel body, and have a 2n-fold rotational symmetry with respect to the axis of rotation.

9. The gearwheel body as claimed in claim 8, wherein the structured web has adjacent, differently structured sectors with different mass distribution, which are present in pairs and can be brought into congruence after a rotation of 180° about the axis of rotation of the gearwheel body.

10. The gearwheel body as claimed in claim 9, wherein the different mass distribution is set by varying a position, a number, or a size of spiral structures, apertures or combinations of these variations of the different mass distribution.

11. The gearwheel body as claimed in claim 1, wherein spiral structure of the structured web is formed by a combination of at least two of the spiral structures comprising ribs, apertures, wavy structures, beads or pockets.

12. A transmission device comprising:
at least two cylindrical wheels configured to transmit a rotational speed and/or a torque of an electric motor, wherein at least one of the cylindrical wheels is designed as a gearwheel body comprises:
a toothed ring; and
a wheel hub;
a structured web extending substantially within a radial plane between a shaft seat and the toothed ring,
wherein the structured web has spiral structures which are thickened in a rib-like manner and are directed from the shaft seat to the toothed ring, and
wherein the spiral structures are aligned such that their spiral shape meets at least the toothed ring at an oblique angle.

13. The transmission device of claim 12, wherein the transmission device is arranged in a motor vehicle.

14. An electric axle drive for a motor vehicle comprising:
at least one electric machine;
a transmission device comprising:
at least two cylindrical wheels configured to transmit a rotational speed and/or a torque of an electric motor, wherein at least one of the cylindrical wheels is designed as a gearwheel body comprises:
a toothed ring; and
a wheel hub;
a structured web extending substantially within a radial plane between a shaft seat and the toothed ring,
wherein the structured web has spiral structures which are thickened in a rib-like manner and are directed from the shaft seat to the toothed ring, and
wherein the spiral structures are aligned such that their spiral shape meets at least the toothed ring at an oblique angle; and
a differential; and
an inverter.

15. The electric axle drive of claim 14, wherein the electric axle drive is arranged in a motor vehicle.
